(19) United States
(12) Patent Application Publication
(10) Pub. No.: US 2002/0111935 A1
(43) Pub. Date: Aug. 15, 2002

(54) System and method for processing travel data in a relational database

(76) Inventors: Terrell Jones, Arlington, TX (US); Roger Kelly, Grapevine, TX (US)

Correspondence Address: Finnegan, Henderson, Farabow,, Garrett & Dunner, L.L.P., 1300 I Street, N.W., Washington, DC, 20005-3315, US

(21) Appl. No.: 09/990,779

(22) Filed: Nov. 14, 2001

Related U.S. Application Data
(60) Provisional application No. 60/248,000, filed on Nov. 14, 2000.

(51) Int. Cl. G06F 7/00

(52) U.S. Cl. 707/1

(57) ABSTRACT

A method and apparatus are disclosed for processing a query of a travel database. The method comprises receiving a selected arrival location and a selected departure location. A set of desirable fares is found between the arrival location and the departure location and possible itineraries are constructed between the arrival location and the departure location associated with the desirable fares. A set of rules is applied to the possible itineraries. An availability portion of the travel database is queried for available travel units for the one or more travel segments based upon the applied set of rules and the possible itineraries. The available travel units are displayed in a calendar-based user interface.

### RELATED APPLICATION

This application claims the benefit of priority from provisional U.S. patent application Ser. No. 60/248,000, filed Nov. 14, 2000, which is expressly incorporated by reference herein.

### BACKGROUND OF THE INVENTION

1. Field of the Invention

The present invention relates to relational databases for holding travel data, and more particularly, to a system and method for processing travel data in a relational database.

2. Background and Material Information

Databases for organizing travel data have been known for many years.

Such databases track the availability of travel units (e.g., seats, berths, rooms, compartments, rental cars, tickets, and the like), wherein an available travel unit is a travel unit that is available for sale. These databases typically utilize a host-based flat-file database architecture, which does not allow for great flexibility in querying the database. For example, users of the database had only very rigid query options due to the one-to-one relationship of data in such database architecture schemes.

In the area of airline reservation databases, airlines send availability status messages (AVS Messages) to a number of customer reservations systems (CRS). The AVS messages act incrementally to change the availability of airplane seats in each of the CRS. In the prior art, the incremental AVS messages must be in an order that is known, so that changes to a reservations database are made in an orderly way. Each AVS message typically comprises an encoded message denoting airline, flight number, departure date, class of service (e.g., fare class), and status. An AVS message may appear as follows:

AA0050V20NOV CL DFWNRT

This example message corresponds to American Airlines Flight 50 on November 20th between Dallas/Fort Worth (DFW) and Tokyo Narita Airport (NRT). The “V” indicates a class of service or fare class. Fare classes are typically defined by the travel provider. The “CL” in the AVS message is a status portion that indicates that the “V” fare class on this particular flight should be closed. As used herein, a closed fare class on a flight denotes that there are no available seats available for that fare class on that flight. An open fare class on a flight denotes that there are one or more seats available for that fare class on that flight.

Thus, the status portion of the AVS message encodes the intended effect an AVS message should have on flight availability. Typical status portions may, for example, call for the opening or closing of a particular flight segment, or the opening or closing of a flight segment and any dependent intermediate segments. Exemplary status indicators are presented in Table 1.

TABLE 1

| | |
|---|---|
| CR | Flight closed: Request only; space may be requested |
| CC | Flight closed: Waiting list closed |
| CL | Flight closed: Waiting list open |
| LR | Segment closed: Request only; space may be |
| | requested |
| LC | Segment closed: Waiting list closed |
| LL | Segment closed: Waiting list open |
| AS | Open this flight segment and any prior dependent |
| | segments affected |
| LA | Open this segment if and only if it has not been closed |

In this example, any segment that has been closed by a “C” type message (e.g., CR, CC, or CL) cannot be opened by an LA message. An LA message can only open a segment closed by an “L” type message (e.g., LR, LL, or LC).

In the example AVS message above, the Dallas/Fort Worth to Tokyo flight record corresponds to a number of legs and segments. A leg is a portion of a scheduled flight comprising one takeoff and one landing. Flight 50, for example, may comprise 3 legs: (1) Dallas/Fort Worth to Los Angeles (DFW-LAX), (2) Los Angeles to Honolulu (LAX-HNL), and (3) Honolulu to Tokyo (HNL-NRT). A segment is any possible combination of legs comprising all or a portion of a scheduled flight. Similarly, Flight 50 may comprise 6 segments: Dallas/Fort Worth to Los Angeles (DFW-LAX), Dallas/Fort Worth to Honolulu (DFW-HNL), Dallas/Fort Worth to Tokyo (DFW-NRT), Los Angeles to Honolulu (LAX-HNL), Los Angeles to Tokyo (LAX-NRT), and Honolulu to Tokyo (HNL-NRT).

Data in traditional CRS are arranged in a host-based database architecture. As such, when the CRS is queried in the traditional host-based database model, a user is limited to queries for flights between certain city pairs on specific days and at specific times. The user can then select from the database results to look at flights on those certain days and those certain times. However, traditional CRS database systems do not incorporate availability information into these queries. Thus, a user often finds a scheduled flight for a desired day and time, but the flight will not necessarily be available.

Furthermore, data results gathered from traditional host-based flat-file database architectures do not incorporate the many restrictions and travel rules that are present in the airline reservation industry. Thus, users of the database must go through an exorbitant number of queries to find desired airline reservations at a desired price which meet all airline restrictions.

Prior implementations for processing AVS messages have included systems having proprietary file retrieval systems, e.g., mainframe systems using Transaction Processing Facility (TPF), a computer assembly language known in the art. Such implementations are procedure-oriented in nature and, thus, complex and inflexible. Further, these implementations are not amenable to standard database protocols, such as Structured Query Language (SQL).

What is needed is a database which incorporates availability data, applicability data, rules, and restrictions in a format that allows for easy and flexible querying by a user and that allows for updating with new AVS messages. What is also needed is a logical simplification of the process for applying AVS Messages to such a database.

### SUMMARY OF THE INVENTION

A method and apparatus are disclosed for processing a query of a travel database. The method comprises receiving a selected arrival location and a selected departure location. A set of desirable fares is found between the arrival location and the departure location and possible itineraries are constructed between the arrival location and the departure location associated with the desirable fares. A set of rules is applied to the possible itineraries. An availability portion of the travel database is queried for available travel units for the one or more travel segments based upon the applied set of rules and the possible itineraries. The available travel units are displayed in a calendar-based user interface.

Also disclosed are a method and apparatus for administering an availability portion of a relational travel database. The method comprises receiving an availability message from a first travel provider and analyzing the availability message to determine one or more affected travel segments. A schedule portion of the relational travel database is queried for the one or more affected travel segments. A record is written to an availability portion of the relational database based on a status portion of the availability message if the one or more affected travel segments are found in the schedule portion of the relational database.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the invention.

In the drawings:

FIG. 1 is a diagram of an exemplary system environment consistent with an embodiment of the present invention;

FIG. 2 is a diagram showing an exemplary flow of data in accordance with an embodiment of the present invention;

FIG. 3 is a flow diagram showing an exemplary method of querying a database of travel data in accordance with an embodiment of the present invention;

FIG. 4 is a diagram of an exemplary maintenance process for updating a travel database in accordance with an embodiment of the present invention;

FIG. 5 shows an exemplary user interface consistent with an embodiment of the present invention;

FIG. 6 illustrates another exemplary user interface in accordance with an embodiment of the present invention;

FIG. 7 illustrates an exemplary output screen consistent with an embodiment of the present invention;

FIG. 8 illustrates a flowchart of an exemplary method for processing AVS messages in accordance with an embodiment of the present invention; and

FIG. 9 shows a listing of some records from an availability portion of an exemplary relational database consistent with an embodiment of the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

Broadly stated, the present invention relates to a system and method for processing travel data in a relational database. More particularly, embodiments consistent with the present invention provide for methods, systems, and user interfaces for processing queries of and administering data in a relational travel database.

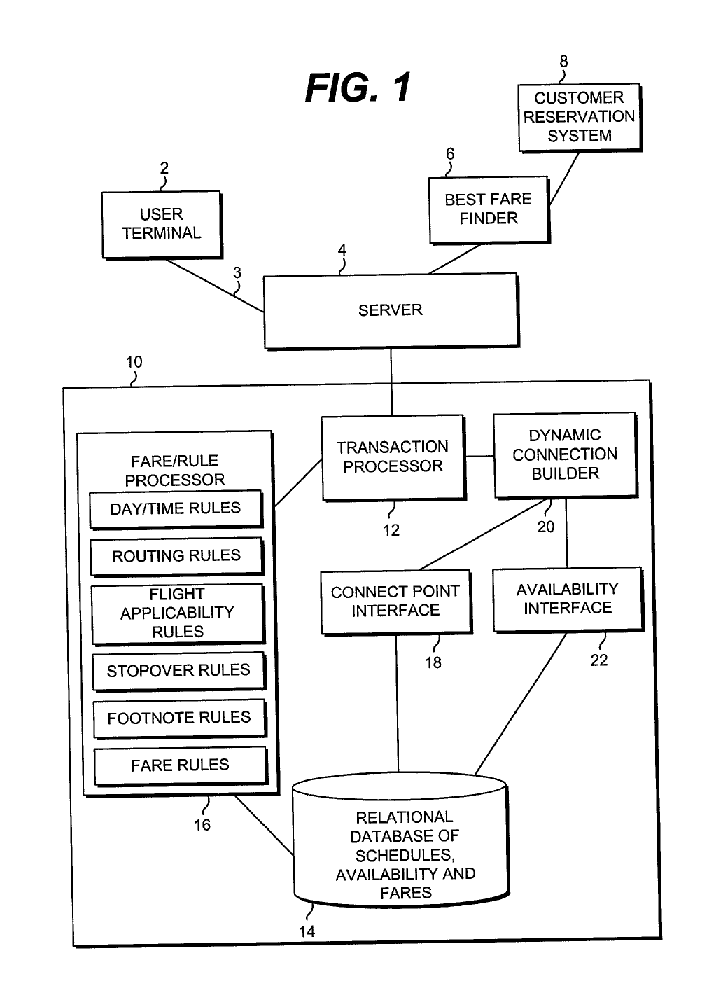

FIG. 1 illustrates an exemplary system environment within which an embodiment of the present invention may be implemented. Turning to FIG. 1, a user terminal 2 having an input device (not shown) and a display unit (not shown) is provided where a user can enter desired travel information and locations, such as departure city, arrival city, and desired fare. User terminal 2 is operatively connected to server 4 via link 3. Link 3 can be any known wireless and/or wired network connection, for example the Internet. Server 4 is operatively connected to best fare finder 6. Best fare finder 6 contains algorithms which find desirable fares, such as the lowest fares available in customer reservation system 8. Thus, fare finder 6 and customer reservation system 8 are connected over a real-time link.

Server 4, in an exemplary embodiment, comprises a World Wide Web server for serving web pages to user terminal 2. Server 4 is operatively connected to a travel data system 10. Server 4 interacts with travel data system 10 through a transaction processor 12, which processes requests from server 4. As used herein, “processor” may include a memory for storing an application program and a processor coupled to the memory, wherein the processor is configured under control of the application program. Travel data system 10 comprises relational database 14. Relational database 14 contains travel records of schedule availability and fare data which are arranged relationally.

Relational database 14 interacts with transaction processor 12 via several links including fare/rule processor 16. Fare/rule processor 16 takes records of fare data from relational database 14 and applies this information against a set of rules propagated by travel providers. Such rules may comprise, for example, minimum required stays, maximum allowed stays, advanced purchase requirements, and the like. Fare/rule processor 16 typically comprises software code for applying fare data against rules in any known manner, such as that disclosed in a publicly available standard entitled, “ATPCO Automated Rules and Footnotes Subscription,” by the Airline Tariff Publishing Company (ATPCO), for example. Thus, processor 16 serves to validate available travel segment against rules from travel providers.

Relational database 14 is also connected to connect point interface 18. Connect point interface 18 serves to pare down possible connection points between travel segments from those that are merely possible to those that are reasonable. For example, when one is attempting to book a flight from Dallas to Chicago, one may possibly connect on a flight in Cairo, Egypt. However, connect point interface 18 would exclude such an unreasonable connection. Nevertheless, connect point interface 18 would allow a reasonable connection, such as one made in St. Louis, Mo. Those skilled in the art will appreciate that an implementation of connect point interface 18 may be empirically developed using heuristics and experience, and the interface may comprise, for example, a table of city pairs linked by allowable connection points.

Travel data system 10 also comprises availability interface 22. Availability interface 22 is operatively connected to relational database 14. Interface 22 serves to find available seats provided by travel providers which meet desired criteria. Once available seats are found within relational database 14, these seats are passed to dynamic connection builder 20. Dynamic connection builder 20 relates the available seats to the reasonable connection points provided from connection point interface 18. Once this information is resolved, dynamic connection builder 20 passes the available and applicable seats back to transaction processor 12. Applicable and available seats are then passed to server 4 for eventual display on user terminal 2.

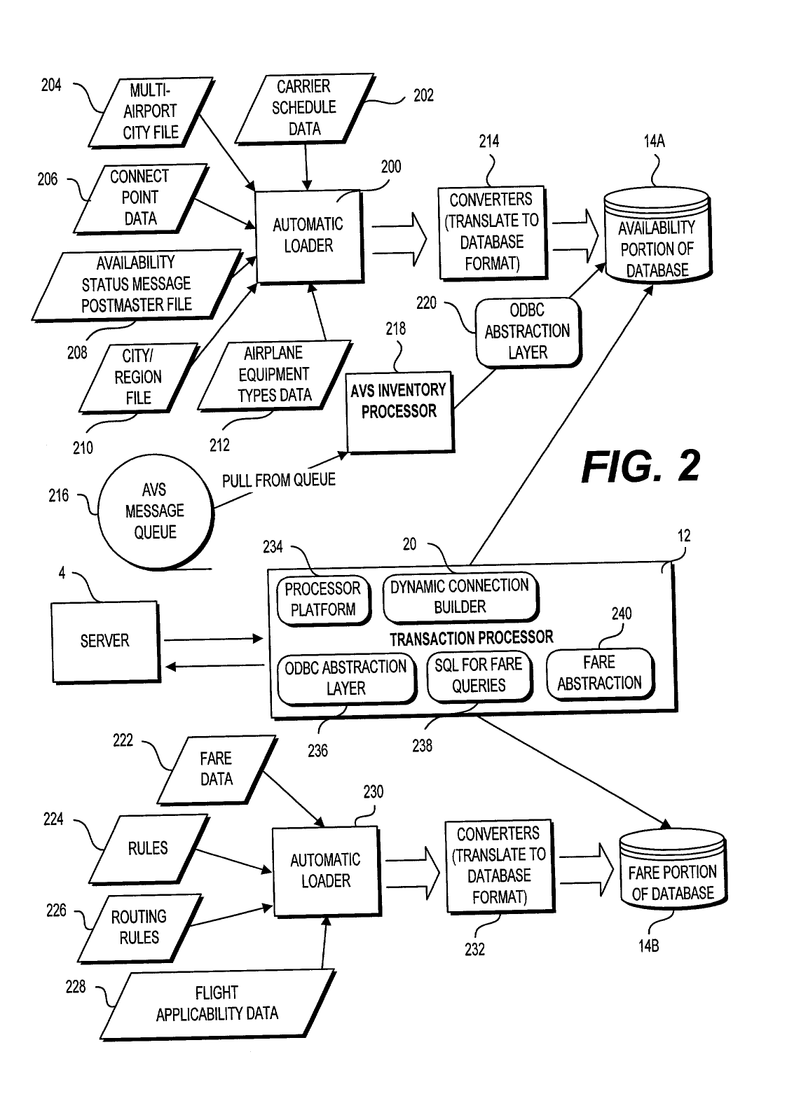

FIG. 2 is a diagram showing how data are loaded from various data sources into exemplary relational database 14 according to an embodiment of the present invention. Many data feeds are provided to automatic loader 200 for eventual entry into an availability portion 14A of database 14. For example, in the airline industry, these data feeds may include carrier schedule data 202. Carrier schedule data 202 represents raw schedules provided by the airlines, e.g., schedules irrespective of bookings, availability, or applicability. Multi-airport city file 204 contains information for metropolitan areas having multiple airports serving the metropolitan area. For example, in Washington, D.C., three major airports serve the metropolitan area: Reagan National Airport (DCA), Baltimore-Washington Airport (BWI), and Dulles International Airport (IAD). Using data from multi-airport city file 204, flight schedules can be constructed which take advantage of metropolitan areas having the service of multiple airports.

Connect point data 206 is a data feed of all possible connection points for a given departure city and arrival city, as provided by connect point interface 18. Availability status message postmaster file 208 is loaded once or as needed to availability portion 14A. This postmaster file 208 represents a snapshot of flight availability at one point-in-time and is processed when needed to initialize the system in accordance with the present invention. One skilled in the art will recognize that a database system will occasionally need to be initialized when, for example, new hardware or software is introduced or when computers supporting the system are rebooted. City/region file 210 ties cities surrounding an airport to the airport. For example, Alexandria, Virginia, a suburb of Washington, D.C., would be related to the Washington, D.C., airports for searching purposes City/region file 210 allows users to enter suburban locations and retrieve information on the airport that is closest to them. City/region file 210 may be developed using heuristics and experience, and it may also be developed by determining a closest airport based on latitude and longitude calculations. Finally, airplane equipment types data 212 provides availability portion 14A with information regarding the types and sizes of the planes used for the various airline routings. Equipment types data 212 are particularly useful in planning the connection time needed for transferring planes in a given city. For example, when a passenger must disembark a relatively large Boeing 747 airplane to catch another flight, that passenger will need more time on average, than a passenger connecting from a smaller plane.

Thus, data feeds 202, 204, 206, 208, 210, and 212 are fed into automatic loader 200. Automatic loader 200 detects the presence of new data feeds and automatically triggers a conversion process in converters 214. Converters 214 take data provided by the automatic loader 200 and translate this information into formats recognizable by availability portion 14A. The translation of data may be accomplished using any known conversion schema that is known in the art.

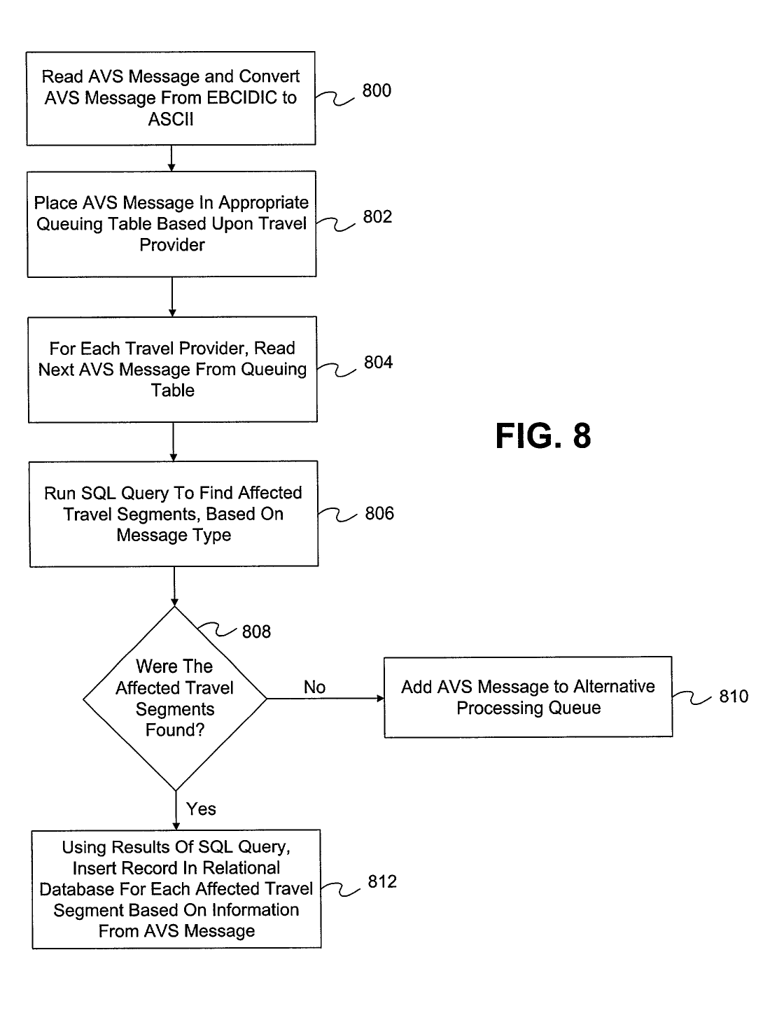

Also supplementing the availability portion 14A of database 14 is AVS message queue 216. Queue 216 takes incremental messages from airlines relating to changes in the availability of airline seats on each airline. These messages are fed into AVS inventory processor 218, where data validation checks may be performed. A determination may be made in processor 218 via software or algorithms how the AVS messages will affect the inventory of available seats based on publicly available standards, for example, the “Standard Schedule Information Manual” and “Reservations Interline Message Procedures” by the International Air Transport Association (IATA). Once the AVS messages are processed in inventory processor 218, these messages are moved into abstraction layer 220, which converts the messages into the proper database format. For example, these messages can be translated into Open Database Connectivity (ODBC) format, a widely accepted and conventional Application Programming Interface (API) format for database access. As such, abstraction layer 220 feeds directly into availability 14A, where records are written reflecting changes in the inventory. A more detailed discussion on the processing of AVS messages is presented infra with reference to FIG. 8.

Again with reference to FIG. 2, several other data feeds feed a fare portion 14B of database 14. These other data feeds comprise fare data 222 and rules 224. Fare data feed 222 represents the fares that can be applied to various flights, and rules data feed 224 represents the rules for applying fares to various flights. Routing rules 226 place restrictions on the cities and routes that may be used for planning an itinerary. Finally, flight applicability data 228 qualify the application of certain fares to the various cities and routes. Flight applicability data 228 typically comprise data from travel providers denoting restrictions on applying certain fares to certain flights.

All of the data, including fare data 222, rules 224, routing rules 226, and flight applicability data 228, are routed into automatic loader 230. Once it receives this information, automatic loader 230 reacts to the input of data for any of these various sources. Automatic loader 230 moves data into data converters 232 to translate raw data into database format. Once converters 232 have completed the translation, they feed data in data base format to the fare portion 14B.

As mentioned with reference to FIG. 1, a server 4 interacts with processor 12. In one embodiment, transaction processor 12 comprises a processor platform 234 for running transaction processor 12. Also included is dynamic connection builder 20 as mentioned with reference to FIG. 1. ODBC abstraction layer 236 takes raw data from server 4 and changes it to a format recognizable by database 14, as is known in the art. Transaction processor 12 also comprises SQL for fare queries translator 238, which translates a user's query of the system into SQL. Finally, a fare abstraction portion 240 of transaction processor 12 normalizes the format of fare information into a format recognizable by database 14, again using ODBC.

Transaction processor 12 then feeds into both the availability portion 14A and the fare portion 14B of database 14. Database 14 may comprise one or more than one individual database unit in an exemplary embodiment of the present invention.

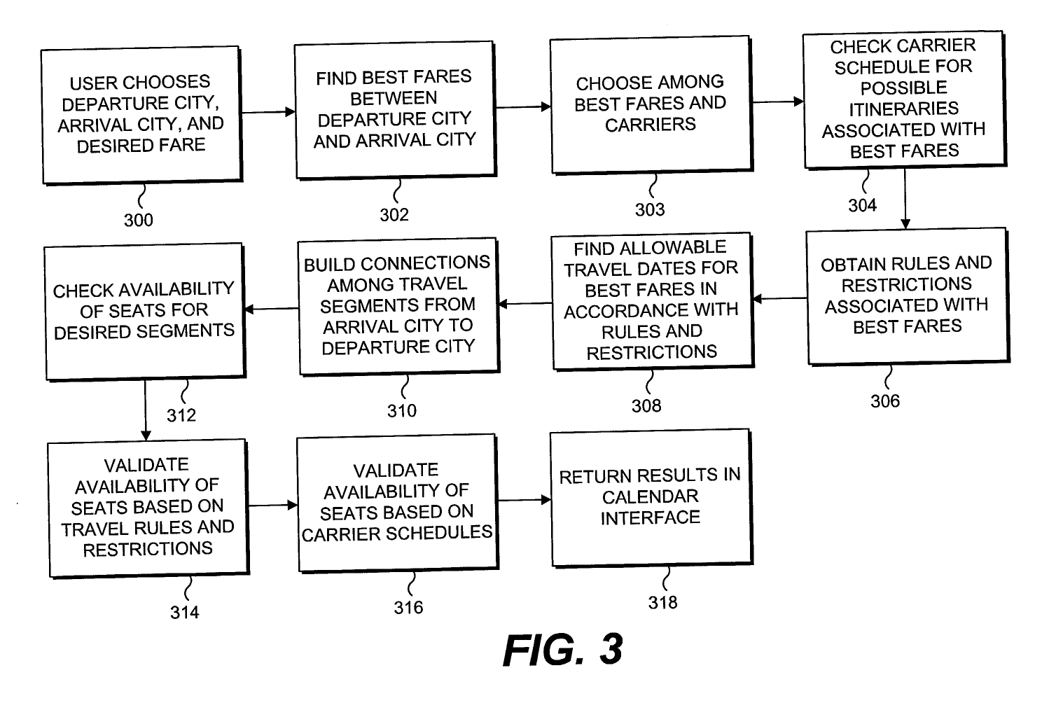

FIG. 3 is a flow diagram showing an exemplary method of querying a database of travel data in accordance with an embodiment of the present invention. In step 300, a user chooses a departure city, an arrival city, and a desired fare. Next, desirable (e.g., best or lowest) fares are found between the input departure city and input arrival city (step 302). A user may then select the desired fare or desired carrier from a secondary input screen showing the best fares (step 303). In an exemplary embodiment, the lowest fares for the next 90 days are passed to server 4 as 90 records, one per day. Each record indicates whether or not the fare is available on the day associated with the record. Scheduled carriers are then checked for possible itineraries associated with these best or lowest fares in step 304.

Owing to the multitude of rules and restrictions associated with travel carriers, the system reviews rules and restrictions (step 306) to find allowable travel dates for the best fares that comply with the rules and restrictions (step 308). Step 306 may be implemented by querying the fare portion of the relational database for rules and restrictions related to the best fares. Next, the fares may be filtered based on footnote and travel validity. Footnote and travel validity refers to prespecified dates during which the contract terms underlying a fare class are valid. Filtering of fares comprises applying the contract terms associated with the best fares in order to include fares that fall within the footnote and travel validity dates and exclude fares that fall outside of the footnote and travel validity dates. A fare may then be deemed effective in step 308 if it is valid for the time of requested travel, e.g., the dates associated with the best fares. Once a best fare is deemed effective, a rule set associated with the fare is loaded into fare/rule processor 16. Next, the input date ranges are filtered for applicability in fare/rule processor 16. In one example, applicability may be based on the “ATPCO Automated Rules and Footnotes Subscription,” as mentioned above. Qualifying fares are then returned to fare/rule processor 12, while fares that did not pass the rules are excluded.

Once allowable travel dates for best fares are found, the system builds connections among a plurality of travel segments from the arrival city to the departure city in step 310. Next, in step 312, the system checks availability of seats for desired travel segments as connected in step 310.

Seat availability is then validated in step 314 based on the previously mentioned travel rules and restrictions. This step acts as a check against the results obtained in step 308. In step 316, seat availability is validated against travel providers' schedules, acting as a check against the possible itineraries found in step 304. In the exemplary embodiment, the data passed comprise the above-mentioned 90 records (one per day of the search), only now these data include applicability/non-applicability and availability/unavailability of fares. A person skilled in the art will recognize that applicability of fares refers to whether a certain fare applies to a desired travel day or time, while availability of fares refers to whether an applicable fare is or is not sold out.

Finally, results are returned to a user interface in step 318. In an exemplary embodiment according to the present invention, the results are displayed in a convenient calendar interface.

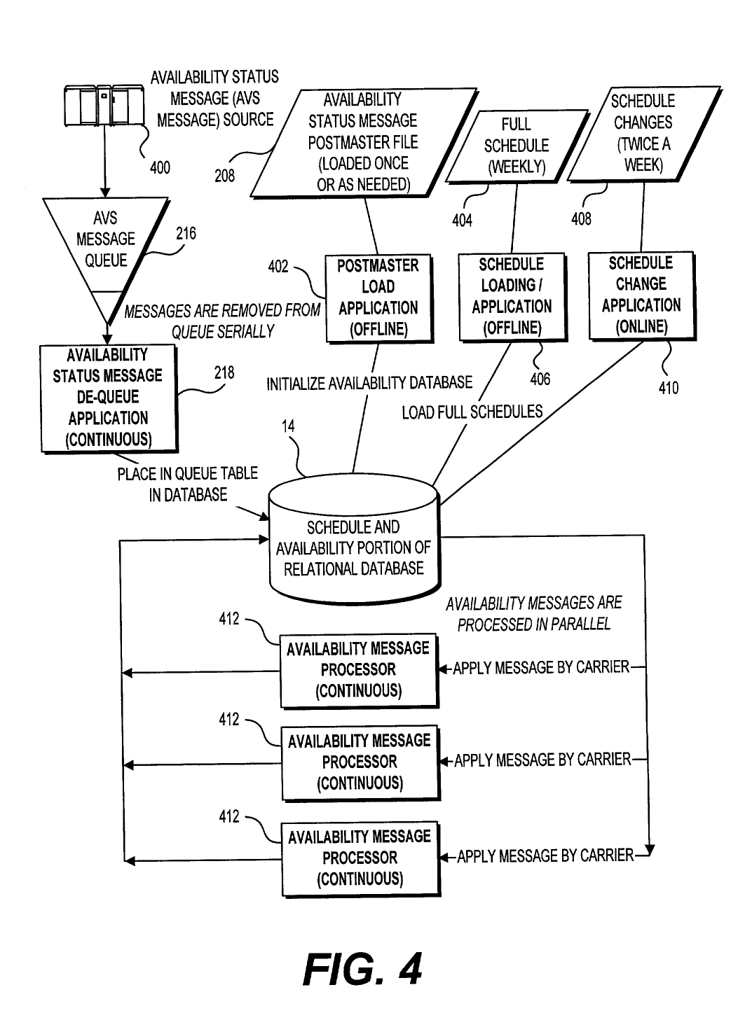

FIG. 4 is a diagram of an exemplary maintenance process for updating a travel database in accordance with an embodiment of the present invention. More generally, FIG. 4 illustrates the way in which the exemplary system of FIG. 1 is updated to reflect changes in availability. Referring to FIG. 4, availability status message source 400 produces AVS messages reflecting changes in availability for the various travel providers. AVS message source 400 is typically operated by a travel provider, e.g., an airline. These AVS messages are removed, usually serially, from queue 216 and entered into availability status message de-queue application 218. De-queue application 218 places all AVS Messages in a queue table (not shown) of database 14. Once all AVS Messages enter database 14, they are then processed in parallel by availability message processors 412. Availability message processors 412 apply each of the AVS messages by travel provider or by groups of travel providers and then loop this processed information back to database 14.

As mentioned previously, availability status message postmaster file 208 is loaded once or as needed to initialize database 14. Postmaster file 208 is typically loaded into postmaster load application 402 on an offline basis to initialize the availability portion of database 14. Furthermore, full schedule 404 may be provided to schedule loading application 406 to load full schedules into the data 14. This schedule load is typically completed on an offline basis. Finally, schedule changes 408 are provided to a schedule change application 410 for entry into database 14. Schedule changes may be entered into the database periodically (e.g., twice a week on an online basis) to ensure that schedules in database 14 are up-to-date.

One aspect of an exemplary embodiment of the present invention is that search results are displayed in a convenient calendar format at user terminal 2. The search results present both availability of desired fares and applicability of the fares to the days in the calendar. Relational database 14 solves the deficiency of prior art systems, namely, the inability of prior art systems to display and integrate availability and applicability data for travel.

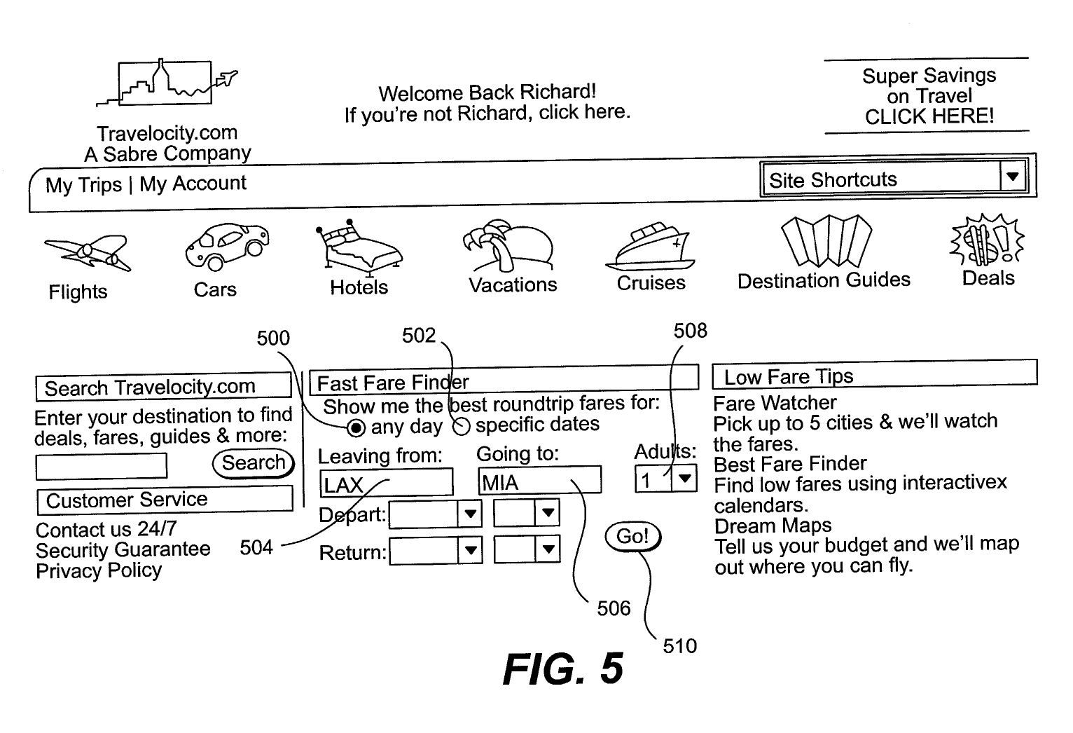

FIG. 5 shows an exemplary user interface consistent with an embodiment of the present invention. A user may manipulate the input screen illustrated in FIG. 5 to query the relational database disclosed herein. For example, a user may choose between “any day” radio button 500 and “specific dates” radio button 502. To obtain availability and applicability information, the user must choose the “any day” radio button 500. Next, the user may choose a departure city or airport code by typing the appropriate information in departure input box 504. Similarly, in arrival input box 506, the user may input a destination location (e.g., city or airport code).

In the illustrated example of FIG. 5, the user has chosen to enter Los Angeles as an origination city in the departure box 504 by entering Los Angeles' airport code, LAX. The user has also entered a destination city, namely, Miami, by designating Miami's airport code, MIA.

Next, the user has the option of entering one or more passengers in passenger number input box 508. Finally, the user may initiate the query by clicking “go” button 510. This go button 510 will start the querying process of the relational database disclosed by the present invention.

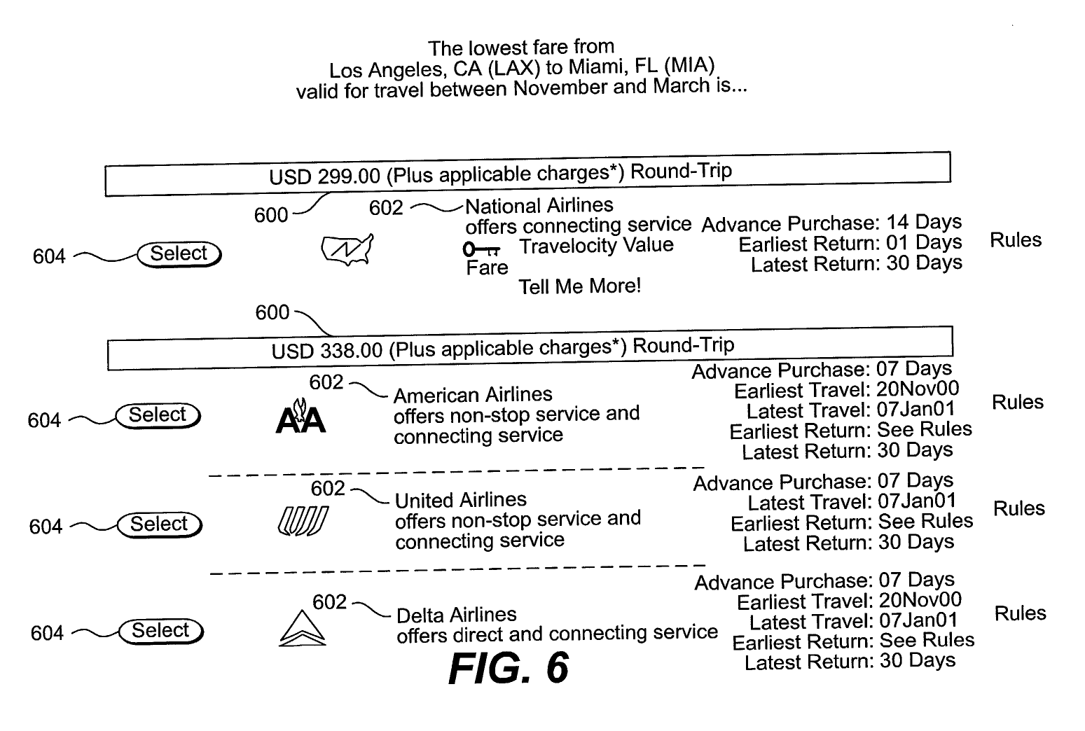

FIG. 6 illustrates another exemplary user interface in accordance with an embodiment of the present invention. FIG. 6 shows an intermediate input screen for display on a user terminal after the querying process has begun. The user has an option of choosing between fares 600 and associated airline carriers 602. The fares 600 and associated airline carriers 602 represent the desirable (e.g., best or lowest) fares available for travel between input departure and arrival cities. Thus, a user may choose the lowest absolute fare or the user may choose a desired airline carrier with an acceptable fare. Whatever the user's choice may be, the user may select that choice from one or more select buttons 604.

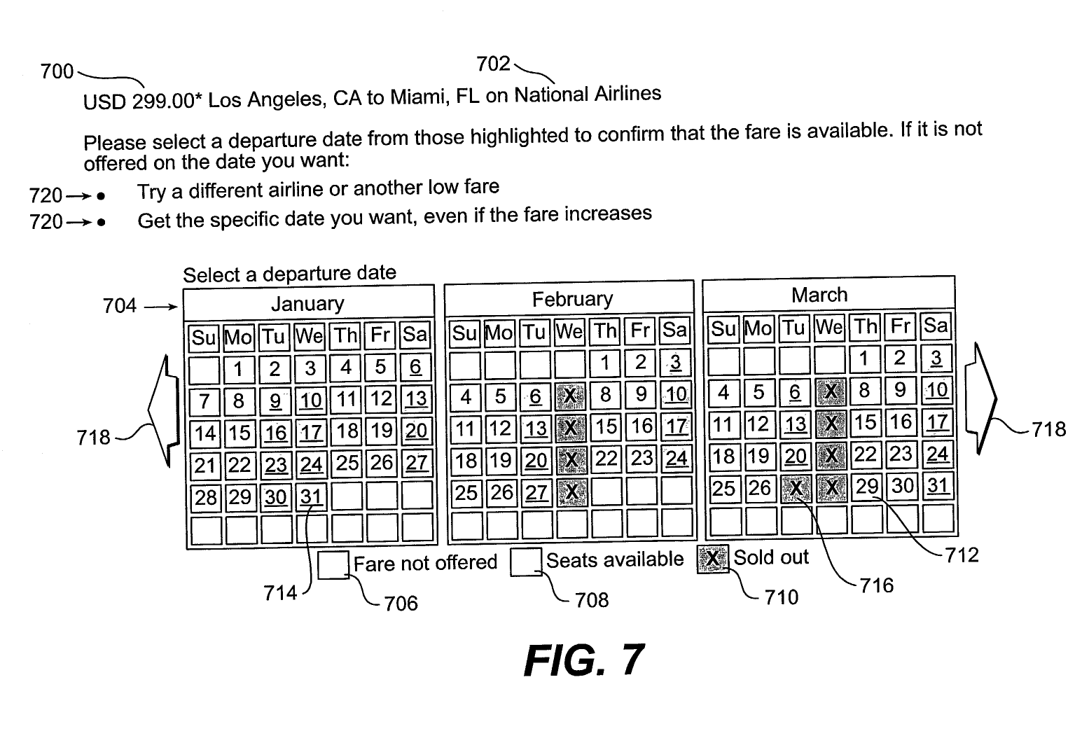

FIG. 7 illustrates an exemplary output screen consistent with an embodiment of the present invention. In particular, FIG. 7 shows an exemplary output screen from the database for display on a user terminal once a query has been completed. The output screen displays both the selected price 700 and the selected airline 702. Calendar 704 displays availability and applicability for the selected fare on the selected airline over a period of time, such as 90 days. Any combination of shading, hyperlinks, symbols (e.g., icons), or other appropriate indicia may be used to indicate whether a fare is available and/or applicable. For example, “fare not offered” legend 706, “seats available” legend 708, and “sold out” legend 710, indicate this availability and applicability of fares. A user may then manipulate calendars 704 by making selections within calendars 704 based on legends 706, 708, and 710. For example, unavailable days 712 appear grayed out, shaded, or are otherwise indicated so as to illustrate the nonavailability and/or nonapplicability of seats on those days at the designated price 700 and on the selected airline carrier 702. Available seat days 714 may appear as hyperlinks on which the user may click to obtain further information on the designated fare 700, the designated airline 702, and the chosen date corresponding to available seat day 714. Finally, sold out days 716 appear crossed out of or may be otherwise indicated in calendar 704, so that the user may not select these dates.

If the user does not wish to travel on the 90 days worth of calendar days displayed by calendar 704, the user may click on calendar scroll icons 718 to move forward or backward in the time period displayed, as desired. Moreover, the user may click on hyperlink 720 to either try a different airline or another low fare, or to get the specific travel date the user desires.

FIG. 8 illustrates a flowchart of an exemplary method for processing AVS messages in accordance with an embodiment of the present invention. In step 800, each AVS message may be read and converted from EBCIDIC format to ASCII format, as is known in the art. Each converted AVS message may then be placed in an appropriate queuing table based upon a particular travel provider (step 802). This allows one travel provider's AVS messages to be processed separately from or in parallel with other travel providers' AVS messages. Processing is initiated in step 804, where, for each travel provider, a next AVS message may be read from an appropriate queuing table. Based on the content of the AVS message (e.g., the AVS message type), an SQL query of the schedule portion of the relational database is run to find affected travel segments (step 806). A determination is made in step 808 whether affected travel segments were found in the relational database. This acts as a check to validate the content of the AVS message and root out any potential errors.

If the affected travel segments are not found in the relational database in step 808 (“No”), then the AVS message which is not found in the relational database is added to a queue for alternative processing (step 810). For example, the alternative processing may comprise placing the unknown AVS message in a “wait” queue. This may relate to the possibility that the AVS message affects a flight for which no schedule record exists in the relational database. The wait queue allows for later processing of the AVS message if a corresponding schedule is eventually added to the relational database.

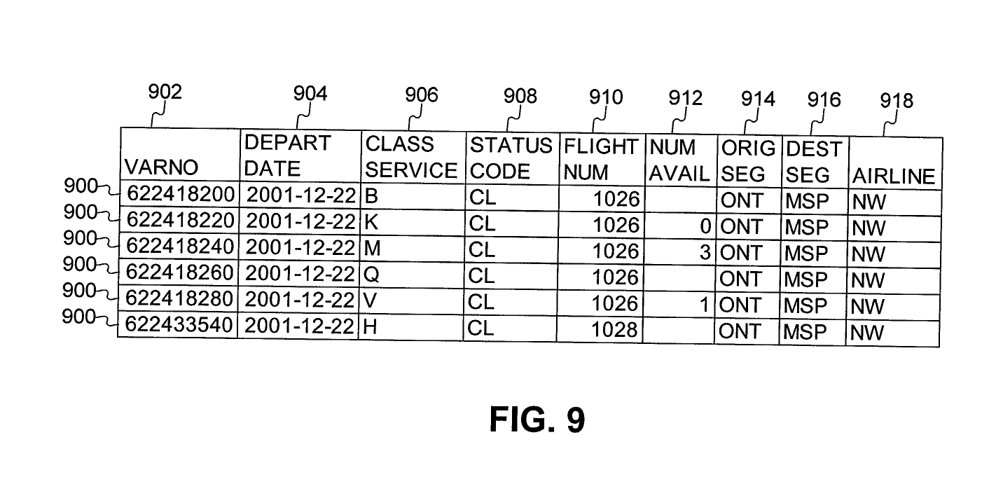

If the affected travel segments are found in the relational database in step 808 (“Yes”), then, using the results of the SQL query, a record is inserted in the availability portion of the relational database for each affected travel segment based on information from the AVS message. Exemplary records for insertion in the availability portion of the relational database consistent with an embodiment of the present invention are now presented with reference to FIG. 9.

Turning to FIG. 9, one or more exemplary records 900 for the availability portion of the relational database are arranged horizontally. A number of columns organize information related to the records 900. VARNO column 900 is a column that holds an arbitrary record identifier for each of the records 900. DEPART DATE column 902 holds the departure date associated with each of the records 900. CLASS SERVICE column 904 holds the departure date of a flight associated with each of the records 900. STATUS CODE column 908 relates to the status portion of the AVS message that encodes the intended effect an AVS message should have on flight availability. FLIGHT NUM column 91 0 holds the fight number of a flight associated with each of the records 900. NUM AVAIL column 912 optionally holds information specifying that there are 0, 1, 2, 3, or 4 or more available seats for a flight associated with each of the records 900. ORIG SEG column 914 holds a code corresponding to the origin point and DEST SEG 916 holds a code corresponding to the destination of a flight associated with each of the records 900. AIRLINE column 918 holds a code corresponding to a travel provider associated with each of the records 900.

An example of the exemplary method of FIG. 8 will now be presented. In the example, the AVS message contains the following:

AA0050V20NOV CL DFWNRT

This corresponds to American Airlines Flight 50 on November 20th between Dallas/Fort Worth (DFW) and Tokyo Narita Airport (NRT). The “V” indicates a class of service, while the “CL” is a status portion that indicates that the “V” fare class on this particular flight should be closed. In actuality, however, Flight 50 comprises 3 legs: (1) Dallas/Fort Worth to Los Angeles (DFW-LAX), (2) Los Angeles to Honolulu (LAX-HNL), and (3) Honolulu to Tokyo (HNL-NRT). Similarly, Flight 50 comprises 6 segments: Dallas/Fort Worth to Los Angeles (DFW-LAX), Dallas/Fort Worth to Honolulu (DFW-HNL), Dallas/Fort Worth to Tokyo (DFW-NRT), Los Angeles to Honolulu (LAX-HNL), Los Angeles to Tokyo (LAX-NRT), and Honolulu to Tokyo (HNL-NRT). This information can be displayed in tabular form showing a first and a last leg number for each segment, as shown in Table 2.

TABLE 2

| Segment | First Leg | Last Leg |
|---|---|---|
| DFW-LAX | 1 | 1 |
| DFW-HNL | 1 | 2 |
| DFW-NRT | 1 | 3 |
| LAX-HNL | 2 | 2 |
| LAX-NRT | 2 | 3 |
| HNL-NRT | 3 | 3 |

Using an SQL query of the schedule portion of the relational database, the Dallas/Fort Worth to Tokyo flight is located. More particularly, segments are located having a first leg number greater than or equal to the leg number whose origin is “DFW” (i.e., 1) and a last leg number less than or equal to the leg number whose destination is “NRT” (i.e., 3). Leg numbers are used to control the range of segments to be closed. In this case, all six segments would be returned from the SQL query. Next, records are inserted in the availability portion of the relational database showing that these six segments are closed.

Another example of the exemplary method of FIG. 8 will now be presented. In this second example, the AVS message is as follows:

AA0050V20NOV AS DFWHNL

The “AS” portion of this AVS message denotes that this flight segment should be opened for the “V” fare class.

Using an SQL query of the schedule portion of the relational database, the Dallas/Fort Worth to Honolulu flight is located. The relevant portion of Flight 50 comprises 2 legs: (1) Dallas/Fort Worth to Los Angeles (DFW-LAX) and (2) Los Angeles to Honolulu (LAX-HNL). Similarly, the relevant portion of Flight 50 comprises 3 segments: Dallas/Fort Worth to Los Angeles (DFW-LAX), Dallas/Fort Worth to Honolulu (DFW-HNL), and Los Angeles to Honolulu (LAX-HNL). Segments are located having a first leg number greater than or equal to the leg number whose origin is “DFW” (i.e., 1) and a last leg number less than or equal to the leg number whose destination is “HNL” (i.e., 2). In this case, all three segments would be returned from the SQL query. Records are inserted in the availability portion of the relational database showing that these three segments are open.

Still another example of the exemplary method of FIG. 8 will now be presented. Consider the AVS message:

AA0050V20NOV LA DFWLAX

The “LA” portion of this AVS message denotes that the segment from Dallas/Fort Worth to Los Angeles should be closed for the “V” fare class, leaving all other segments of Flight 50 unaffected.

Other embodiments of the invention will be apparent to those skilled in the art from consideration of the specification and practice of the invention disclosed herein. For example, a person of ordinary skill in the art may extend the teachings herein to travel data other than that of the airline industry; the teachings are equally applicable to rail travel data, bus travel data, cruise line travel data, hotel travel data, automobile rental travel data, and the like. These and other changes to the system and method above are possible without departing from the spirit and scope of the present invention. Accordingly, it is intended that the scope of the invention be limited only by the following claims.

What is claimed is:

1. A method for processing a query of a travel database, comprising:
receiving a selected arrival location and a selected departure location;
finding a set of desirable fares between the arrival location and the departure location;
constructing possible itineraries between the arrival location and the departure location associated with the desirable fares;
applying a set of rules to the possible itineraries;
querying an availability portion of the travel database for available travel units for the one or more travel segments based upon the applied set of rules and the possible itineraries; and
displaying the available travel units in a calendar-based user interface.

2. The method of claim 1, wherein the calendar-based user interface displays applicability data and availability data simultaneously.

3. The method of claim 2, wherein applicability data comprises an indication of whether a travel unit is allowed on a prespecified day based on the set of rules.

4. The method of claim 2, wherein the availability data comprises an indication of whether a travel unit is at least one of (1) available for sale and (2) sold out.

5. The method of claim 2, wherein the calendar-based user interface comprises a display of at least a portion of a calendar.

6. The method of claim 5, wherein the display further includes user-selectable hyperlinks for selecting a desired travel date.

7. An apparatus for processing a query of a travel database, comprising:
a memory for storing an application program; and
a processor coupled to the memory, the processor configured under control of the application program to:
receive a selected arrival location and a selected departure location,
find a set of desirable fares between the arrival location and the departure location,
construct possible itineraries between the arrival location and the departure location associated with the desirable fares,
apply a set of rules to the possible itineraries,
query an availability portion of the travel database for available travel units for the one or more travel segments based upon the applied set of rules and the possible itineraries, and
cause the available travel units to be displayed in a calendar-based user interface.

8. The apparatus of claim 7, wherein the calendar-based user interface displays applicability data and availability data simultaneously on a display unit.

9. The apparatus of claim 8, wherein applicability data comprises an indication of whether a travel unit is allowed on a prespecified day based on the set of rules.

10. The apparatus of claim 8, wherein the availability data comprises an indication of whether a travel unit is at least one of (1) available for sale and (2) sold out.

11. The apparatus of claim 8, wherein the calendar-based user interface comprises a display on the display unit of at least a portion of a calendar.

12. The apparatus of claim 11, wherein the display further includes user-selectable hyperlinks for selecting a desired travel date.

13. A calendar-based user interface for displaying query results from a database containing travel data comprising:
a calendar showing a plurality of days corresponding to the query;
an availability indicator for each of the plurality of days showing available itineraries relating to the query; and
an applicability indicator for each of the plurality of days showing itineraries relating to the query which apply based on a set of rules and restrictions from travel providers.

14. The user interface of claim 13, wherein the availability indicator comprises a shaded day within the calendar for indicating whether a travel unit is available on the shaded day.

15. The user interface of claim 13, wherein the availability indicator comprises an availability icon associated with a day within the calendar for indicating whether a travel unit is available on the associated day.

16. The user interface of claim 13, wherein the availability indicator comprises a user-selectable hyperlink associated with a day within the calendar for indicating whether a travel unit is available on the associated day.

17. The user interface of claim 13, wherein the applicability indicator comprises a shaded day within the calendar for indicating whether a travel unit is applicable on the shaded day.

18. The user interface of claim 13, wherein the applicability indicator comprises an applicability icon associated with a day within the calendar for indicating whether a travel unit is applicable on the associated day.

19. The user interface of claim 13, wherein the applicability indicator comprises a user-selectable hyperlink associated with a day within the calendar for indicating whether a travel unit is applicable on the associated day.

20. A method for administering an availability portion of a relational travel database, comprising:
receiving an availability message from a first travel provider;
analyzing the availability message to determine one or more affected travel segments;
querying a schedule portion of the relational travel database for the one or more affected travel segments; and
writing a record to an availability portion of the relational database based on a status portion of the availability message if the one or more affected travel segments are found in the schedule portion of the relational database.

21. The method of claim 20, further comprising:
initializing the relational travel database by processing a snapshot of existing availability messages at a predetermined time into the availability portion of the relational travel database.

22. The method of claim 20, further comprising:
placing the availability message in a queue corresponding to the first travel provider.

23. The method of claim 22, further comprising:
processing the availability message corresponding to the first travel provider in parallel with an additional availability message corresponding to a second travel provider.

24. The method of claim 20, further comprising:
adding the availability message to an alternative processing queue if the one or more affected travel segments are not found in the schedule portion of the relational database.

25. The method of claim 20, further comprising:
determining one or more travel legs corresponding to each of the one or more affected travel segments, including an origin leg and a destination leg;
determining a leg number for each of the one or more travel legs;
determining a first leg and a last leg associated with each of the one or more affected travel segments;
identifying affected travel segments whose leg number of the first leg is at least the leg number of the origin leg and whose leg number of the last leg is at most the leg number of the destination leg; and
writing a record to the availability portion of the relational database based on a status portion the availability message for each identified affected travel segment.

26. An apparatus for administering an availability portion of a relational travel database, comprising:
a memory for storing an application program; and
a processor coupled to the memory and operatively connected with the relational travel database, the processor configured under control of the application program to:
receive an availability message from a first travel provider,
analyze the availability message to determine one or more affected travel segments,
query a schedule portion of the relational travel database for the one or more affected travel segments, and
write a record to an availability portion of the relational database based on a status portion of the availability message if the one or more affected travel segments are found in the schedule portion of the relational database.

27. The apparatus of claim 26, wherein the processor is further configured to:
initialize the relational travel database by processing a snapshot of existing availability messages at a predetermined time into the availability portion of the relational travel database.

28. The apparatus of claim 26, wherein the processor is further configured to:
place the availability message in a queue corresponding to the first travel provider.

29. The apparatus of claim 28, wherein the processor is further configured to:
process the availability message corresponding to the first travel provider in parallel with an additional availability message corresponding to a second travel provider.

30. The apparatus of claim 26, wherein the processor is further configured to:
add the availability message to an alternative processing queue if the one or more affected travel segments are not found in the schedule portion of the relational database.

31. The apparatus of claim 26, wherein the processor is further configured to:
determine one or more travel legs corresponding to each of the one or more affected travel segments, including an origin leg and a destination leg;
determine a leg number for each of the one or more travel legs;
determine a first leg and a last leg associated with each of the one or more affected travel segments;
identify affected travel segments whose leg number of the first leg is at least the leg number of the origin leg and whose leg number of the last leg is at most the leg number of the destination leg; and
write a record to the availability portion of the relational database based on a status portion the availability message for each identified affected travel segment.
